(19) United States
(12) Patent Application Publication
(10) Pub. No.: US 2020/0039177 A1
(43) Pub. Date: Feb. 6, 2020

(54) FAUCET MAT

(71) Applicants: USHA P. REDDY, CINCINNATI, OH (US); TRISHA REDDY, CINCINNATI, OH (US); SARA RANA REDDY, CINCINNATI, OH (US)

(72) Inventors: USHA P. REDDY, CINCINNATI, OH (US); TRISHA REDDY, CINCINNATI, OH (US); SARA RANA REDDY, CINCINNATI, OH (US)

(21) Appl. No.: 16/524,526

(22) Filed: Jul. 29, 2019

Related U.S. Application Data
(60) Provisional application No. 62/712,757, filed on Jul. 31, 2018.

(51) Int. Cl. B32B 3/26; B32B 3/06; E03C 1/04

(52) U.S. Cl. CPC B32B 3/266; B32B 3/06; B32B 2571/00; B32B 2307/7265; E03C 1/0401

(57) ABSTRACT

A first embodiment of faucet mat includes a generally flexible body having an absorbent top layer and a liquid impermeable bottom layer. A first hole extends through the body of the mat for receiving a faucet therethrough. The first hole is spaced from the peripheral edge or outer edges of the mat and defines an inner mat edge that is configured to engage a lower end or lower portion of the faucet. One or more additional holes can be provided for receiving additional sink parts therethrough. A slit extends from each hole to the peripheral edge. One or more suitable fasteners can be provided along each inner mat edge, slit, or both.

### CROSS-REFERENCE TO RELATED APPLICATION

This application claims the benefit of U.S. Provisional Patent Application Ser. No. 62/712,757, filed Jul. 31, 2018.

### FIELD

The disclosure of the present patent application relates to household sink accessories, and particularly to a faucet mat for placement on a countertop to encompass a lower portion of a faucet, knob and/or other countertop mounted sink fixtures.

### DESCRIPTION OF THE RELATED ART

Water damage to countertops and cabinets around a sink is a common household problem. Generally, however, the countertop area from which the sink faucet and knobs extend is most vulnerable to water damage. Repeated water splashing or dripping from use of the faucet causes water to collect at the junction between the countertop and the faucet or knob extending therefrom. This accumulation of moisture eventually leads to mold and fungus growth.

Thus a faucet mat solving the aforementioned problems is desired.

### SUMMARY

A faucet mat is configured for placement on a countertop surface and around a lower portion of a faucet, knob and/or other sink part extending from the countertop.

A first embodiment of the faucet mat includes a generally flexible body having an absorbent top layer and a liquid impermeable bottom layer. A first hole extends through the body of the mat for receiving a faucet therethrough. The first hole is spaced from the peripheral edge or outer edges of the body and defines an inner mat edge that is configured to engage a lower end or lower portion of the faucet. One or more additional holes can be provided for receiving additional sink parts therethrough. A slit extends from each hole to the peripheral edge. One or more suitable fasteners can be provided along each inner mat edge, slit, or both.

A second embodiment of the faucet mat includes a flexible body having an absorbent top layer and a liquid impermeable bottom layer. A plurality of holes extends through the body. The holes can be spaced from outer edges of the mat or extend to a side edge of the mat. The holes define inner mat edges that engage a lower end or lower portion of the corresponding sink fixture. One or more fasteners can be provided at the inner mat edges along the holes to facilitate securing the edges together if are gaps between the inner mat edge and the corresponding sink fixture.

A third embodiment of the faucet mat includes a first section and a second section detachably connected to the first section. Both the first section and the second section include an absorbent top layer and a liquid impermeable bottom layer. Hook-and-loop fastener or other suitable fastener can be provided for detachably connecting the faucet mat sections together.

These and other features of the present disclosure will become readily apparent upon further review of the following specification and drawings.

### BRIEF DESCRIPTION OF THE DRAWINGS

FIG. 1 is an environmental, perspective view of a first embodiment of a faucet mat.

FIG. 2 is a top view of the faucet mat of FIG. 1, with the faucet and soap dispenser removed for clarity.

FIG. 3 is an environmental, perspective view of a second embodiment of the faucet mat.

FIG. 4A is a top view of a first variation of the faucet mat of FIG. 3, with the faucet and soap dispenser removed for clarity.

FIG. 4B is a top view of a second variation of the faucet mat of FIG. 3, with the faucet and soap dispenser removed for clarity.

FIG. 5 is a front view of the faucet mat of FIG. 3

FIG. 6A is a top view of a third embodiment of the faucet mat.

FIG. 6B is an enlarged, fragmented top view of exemplary fastening edges of the faucet mat.

FIG. 7 is an environmental, perspective view of the faucet mat of FIG. 6 and first type of sink fixture.

FIG. 8 is an environmental, perspective view of the faucet mat of FIG. 6 and a second type of sink fixture.

Similar reference characters denote corresponding features consistently throughout the attached drawings.

### DETAILED DESCRIPTION OF THE PREFERRED EMBODIMENTS

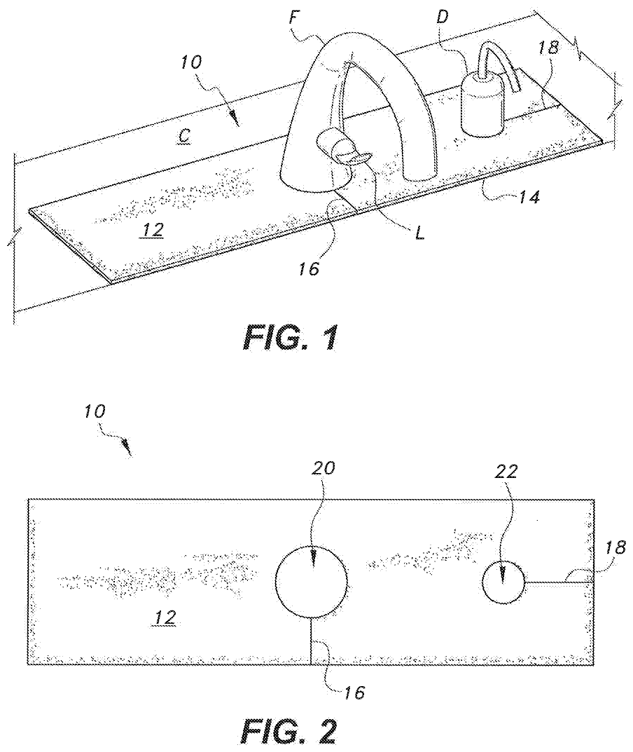

A faucet mat, according to the present teachings, is configured for placement on a countertop surface and around a lower portion of a faucet, knob and/or other sink part extending from the countertop. As shown in FIGS. 1-2, a first embodiment of a faucet mat 10 includes a generally flexible and resilient body having a top layer 12 and a bottom layer 14 below the top layer 12. The top layer 12 of the faucet mat 10 can include an absorbent material, such as a super absorbent polymer, microfiber, or cotton. The bottom layer 14 of the faucet mat 10 can include a material that is impermeable to liquids to protect countertop C from moisture. Exemplary materials that can be used for the bottom layer 14 can include latex or rubber. Preferably, the faucet mat 10 is formed as a one piece mat. Although the faucet mat illustrated in the drawings has a rectangular body, it is contemplated that the faucet mat can be configured to have any suitable shape.

A first hole 20 extends through the body of the mat 10 for receiving a faucet therethrough. The first hole 20 is spaced from the peripheral or outer edges of the body, and defines an inner mat edge that is configured to engage a lower end or lower portion of the faucet. One or more additional holes can be provided for receiving additional sink parts therethrough. For example, a second hole 22 can optionally be provided for receiving a soap dispenser D (or other similar fixture). As the particular fixture shown in FIGS. 1 and 2 includes a control lever L on the faucet F, rather than separate knobs, only two holes are shown. It should be understood, however, that the faucet mat 10 can be configured to include additional holes for additional sink parts.

As shown, the first hole 20 and the second hole 22 can be defined within a central portion of the mat or spaced from outer, side edges of the mat. The first hole 20 and the second hole 22 can be generally circular, as shown, or any other suitable shape. The mat 10 can include a first slit 16 extending from the first hole 20 to a first edge of the mat 10, and a second slit 18 extending from the second hole 22 to a second edge of the mat 10. The first and second outer edges of the mat are openable at slits 16, 18, respectively, to facilitate positioning the mat 10 around the appropriate sink fixtures.

One or more fasteners can be provided at inner mat edges along at least one of the first hole 20 and the second hole 22 to facilitate securing the edges together if there are gaps between the inner mat edge and the corresponding sink fixture. Fasteners may also be provided along the slit 16 and the slit 18 to close the slits 16 and 18 once the mat 10 is properly positioned. The fasteners can include hook and loop fastener material (such as that sold under the tradename Velcro®), magnets, buttons, ties, or other fastening devices.

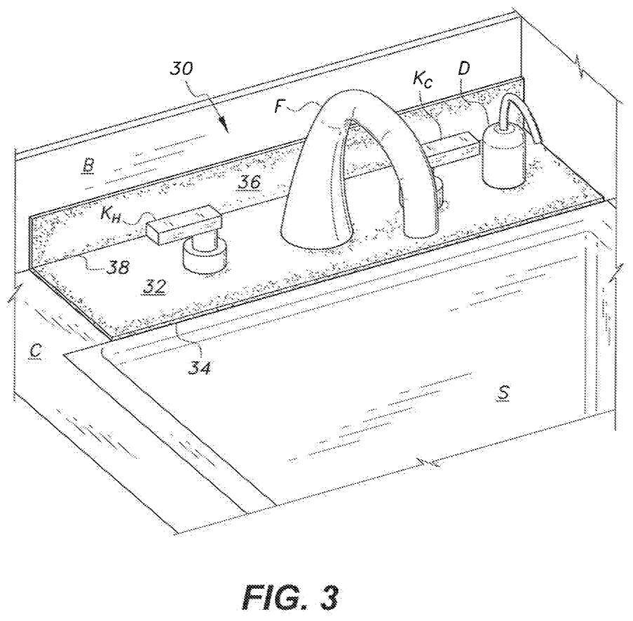

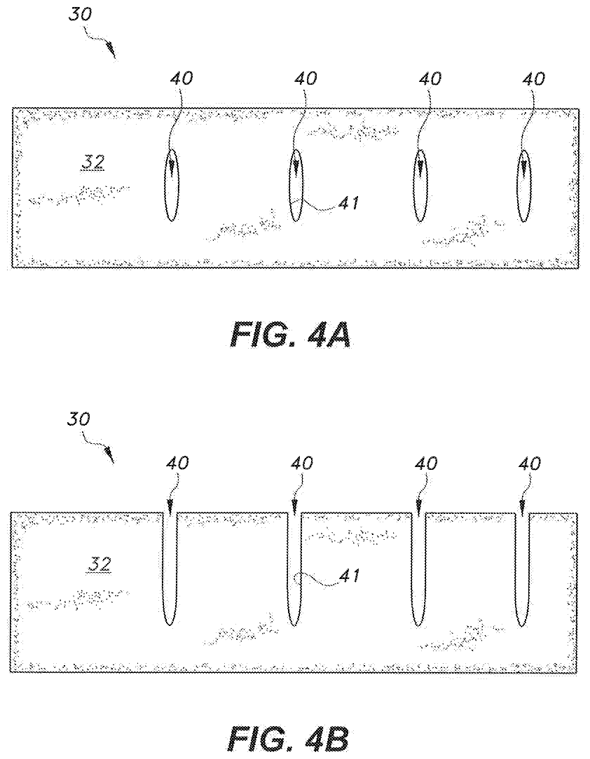

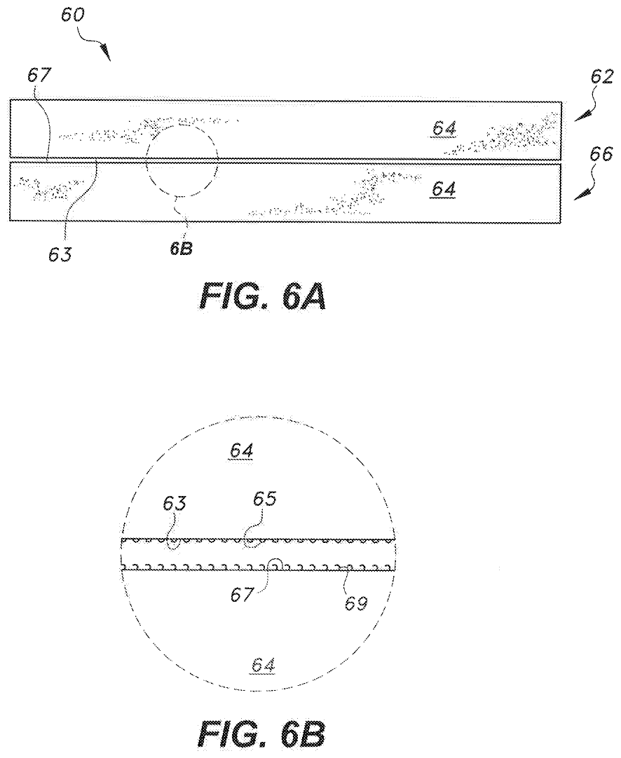

A second embodiment of the faucet mat 30 is shown in FIGS. 3-5, As in the first embodiment, the faucet mat 30 includes a top layer 32 and a bottom layer 34 below the top layer 32. The top layer 32 can include an absorbent material, such as a super absorbent polymer. The bottom layer 34 can include a material that is impermeable to liquids, to protect countertop C. The mat 30 can include a plurality of spaced holes 40 defined therethrough for receiving a corresponding sink fixture (e.g., faucet F, hot water knob KH, cold water knob KC, or soap dispenser D). The holes 40 can be generally oval or any other suitable shape. The holes 40 can be spaced from outer edges of the mat 30, as shown in FIG. 4A, Alternatively, the holes 40 can extend to a side edge of the mat 30, as shown in FIG. 4B. The holes 40 define inner mat edges that engage lower portions of a corresponding sink fixture. One or more fasteners can be provided at inner mat edges 41 along the holes 40 to facilitate securing the edges together if there are gaps between the inner mat edge and the corresponding sink fixture. For example, edge 41 can include hook and loop fastener material, or discrete hooks and loops, as described below with respect to FIG. 6B.

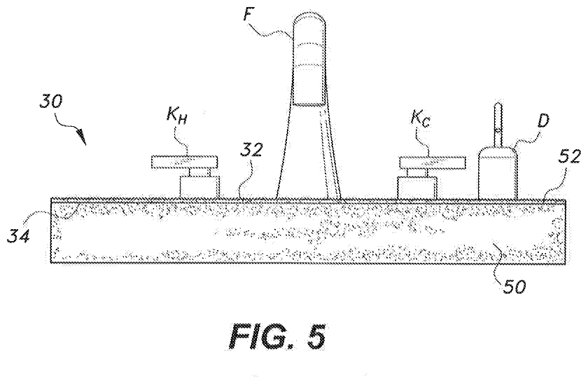

The mat 30 can optionally include additional components for detachable connection thereto. For example, as best seen in FIG. 3, an optional backsplash extension 36 may be connected to the mat 30 at edge or scam 38, to thereby protect the backsplash B as well as the area where the countertop C meets the backsplash B. Seam 38 can include hook and loop fastener material or other suitable fastener(s). As best seen in FIG. 5, an optional overhang extension 50 may be connected to the mat 30 at outer edge or seam 52. The overhang extension 50 is configured to extend into the sink S to thereby protect the countertop C where it meets the sink S. Seam 52 can include a hook-and-loop fastener material or other suitable fastener(s) for attaching the overhang extension 50 to the mat 30.

A third embodiment 60 of the faucet mat is shown in FIGS. 6A-6B, 7 and 8. The faucet mat 60 has a flexible body including a first section 62 and a second section 66 detachably connected to the first section 62, Both the first section 62 and the second section 66 include a top layer 64 and a bottom layer 74. The top layer 64 includes an absorbent material such as a super absorbent polymer. The bottom layer 74 includes a material that is impermeable to liquids, to thereby protect countertop C. One edge 63 of the faucet mat section 62 and/or one edge 67 of the faucet mat section 66 of the faucet mat 30 include hook and loop fastener material or other suitable fastener(s) for detachably connecting the faucet mat section 62 to the faucet mat section 66. In use, the sections 62, 66 are positioned at opposing sides of the sink fixtures and secured together. The fastener(s) holds the edges 63, 67 together, such that the mat closely engages the various fixtures, to avoid water or other liquids from contacting the countertop and other surfaces protected by the faucet mat.

In an embodiment, the edge 63 of the faucet mat section 62 can include a first strip of hook and loop fastener material, while the edge 67 of faucet mat section 66 can include a second, mating strip of hook and loop fastener material. As such, when the edges 63 and 67 are brought into contact with each other, the first and second sections 62, 66 are attached to each other. It should be noted that edge 63 can include the hook type fastener material or the loop type fastener material, as long as the edge 67 includes the mating (opposite) type of material.

Alternatively, discrete hooks and loops may be used, as shown in FIG. 6B. In this embodiment, the first edge 63 of the faucet mat 60 includes a plurality of distinct loops 65. The second edge 67 includes a plurality of distinct hooks 69. In this embodiment, each hook 69 is individually connected to a corresponding loop such that the first and second sections are attached to each other as desired. While the discrete hook and loop fasteners shown in FIG. 6B refer to the third embodiment 60, it should be understood that this type of fastener may be used in any of the embodiments, e.g., at seams and/or edges of any of the embodiments described herein.

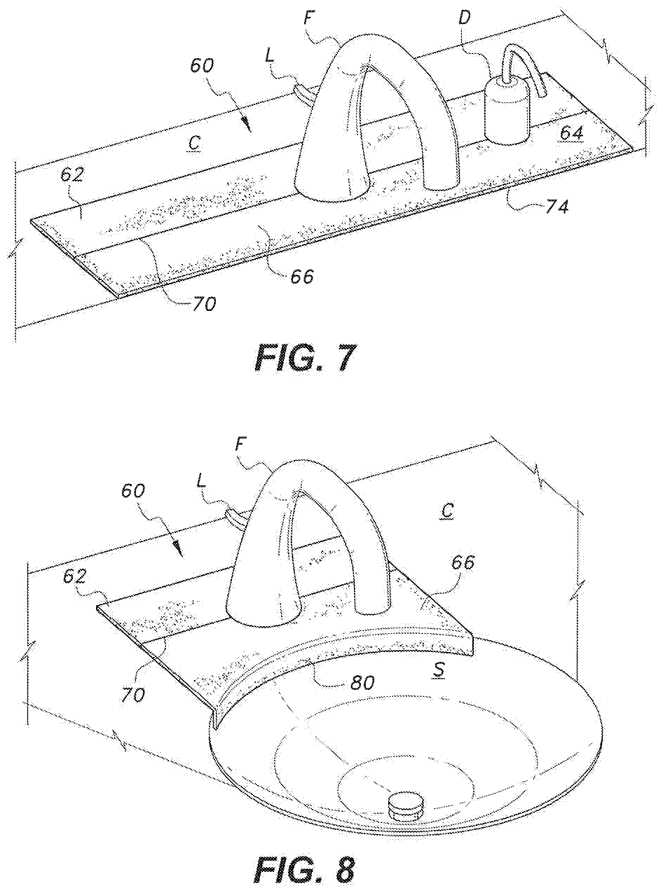

FIG. 7 shows the third embodiment 60 of the faucet mat secured to a fixture similar to the one shown in FIG. 1. This fixture includes a faucet F with a control lever L and a soap dispenser D, (or other similar fixture). The edges 63 and 67 have been attached to form seam 70. The fasteners are not connected where the faucet F and a soap dispenser D are located. Instead, the mat sections 62 and 66 are hunched up around these fixtures to provide a watertight seal.

FIG. 8 shows the third embodiment 60 of the faucet mat applied to a bathroom type sink S. This fixture includes a faucet F with a control lever L. The edges 63 and 67 have been attached to form seam 70, The fasteners are not connected where the faucet F is located. Instead, the mat sections 62 and 66 are bunched up around this fixture to provide a watertight seal. As shown in FIG. 8, section 66 can be configured to include an extension 80 that extends into the sink S, to protect the area where the countertop C Meets the edge of the sink S.

It is to be understood that the faucet mat is not limited to the specific embodiments described above, but encompasses arty and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A faucet mat, comprising:
a flexible body having a top layer and a bottom layer, the top layer including a super absorbent material, the bottom layer including a liquid impermeable material;
a first hole extending through the body and spaced from a first peripheral edge of the mat;
a first inner mat edge formed along the first hole;
a first slit extending from the first hole to the first peripheral edge of the mat; and
a first fastener extending along the first slit.

2. The faucet mat according to claim 1, further comprising a second fastener along the first inner mat edge.

3. The faucet mat according to claim 2, wherein the mat further comprises:
a second hole spaced from the first hole, the second hole extending through the body and spaced from a second peripheral edge of the mat;
a second slit extending from the second hole to the second peripheral edge of the mat;
a second inner mat edge formed along the second hole; and
a third fastener extending along the second slit.

4. The faucet mat according to claim 3, further comprising a fourth fastener extending along the second inner mat edge.

5. The faucet mat according to claim 4, further comprising a backsplash extension connected to a third edge of the mat by a fifth fastener.

6. The faucet mat according to claim 5, wherein the first, second, third, fourth and fifth fasteners are hook-and-loop fasteners.

7. The faucet mat according to claim 6, wherein the hook-and-loop fasteners are formed of discrete hooks and loops.

8. The faucet mat according to claim 6, wherein the hook-and-loop fasteners are formed of hook-and-loop fastener material.

9. The faucet mat according to claim 5, further comprising an overhang extension connected to a fourth peripheral edge of the mat.

10. A faucet mat, comprising:
a flexible body having a top layer and a bottom layer, the top layer including a super absorbent material, the bottom layer including a liquid impermeable material;
a plurality of spaced holes extending through the body, the plurality of holes each having inner mat edges; and
at least one fastener on each inner mat edge to secure the adjacent inner mat edges together.

11. The faucet mat according to claim 10, wherein:
the plurality of spaced holes are spaced from a peripheral edge of the mat.

12. The faucet mat according to claim 10, wherein:
the plurality of spaced holes extend to a peripheral edge of the mat.

13. The faucet mat according to claim 10, wherein the at least one fastener on each inner mat edge is a hook-and-loop fastener.

14. The faucet mat according to claim 13, wherein the hook-and-loop fastener is formed of discrete hooks and loops.

15. The faucet mat according to claim 13, wherein the hook-and-loop fastener is formed of hook-and-loop fastener material.

16. A faucet mat, comprising:
a first flexible body having a first top layer and a first bottom layer, the first top layer including a super absorbent material, the first bottom layer including a liquid impermeable material;
a second flexible body having a second top layer and a second bottom layer, the second top layer including a super absorbent material, the second bottom layer including a liquid impermeable material;
a first fastener extending at least partially along a first edge of the first flexible body; and
a second mating fastener extending at least partially along a second edge of the second flexible body, the first and second fasteners configured to secure the first and second edges together.

17. The faucet mat according to claim 16, wherein the first and second fasteners are hook-and-loop fasteners.

18. The faucet mat according to claim 17, wherein the hook-and-loop fasteners are formed of discrete hooks and loops.

19. The faucet mat according to claim 16, wherein the fasteners extend partially along the first and second edges.

20. The faucet mat according to claim 16, further comprising an overhang extension connected to a third edge of one of the first or second flexible bodies.
